(19) United States
(12) Patent Application Publication
(10) Pub. No.: US 2024/0120860 A1
(43) Pub. Date: Apr. 11, 2024

(54) METHODS FOR IMPROVING RATE OF RISE OF TORQUE IN ELECTRIC MACHINES

(71) Applicant: Tula eTechnology, Inc., San Jose, CA (US)

(72) Inventors: Paul Carvell, San Jose, CA (US); Md. Zakirul Islam, San Jose, CA (US)

(73) Assignee: Tula eTechnology, Inc., San Jose, CA (US)

(21) Appl. No.: 18/374,459

(22) Filed: Sep. 28, 2023

Related U.S. Application Data
(60) Provisional application No. 63/413,298, filed on Oct. 5, 2022.

(51) Int. Cl. H02P 6/28; H02P 6/32; H02P 25/022

(52) U.S. Cl. CPC H02P 6/28; H02P 6/32; H02P 25/022

(57) ABSTRACT

A method of controlling an electric machine having a separately excitable rotor and stator includes exciting the rotor and the stator at the same time to generate an optimal magnetic flux in the electric machine. The method includes maintaining the optimal magnetic flux by reducing a stator current as a rotor current rises. The method also includes providing a torque current to the stator as the rotor current rises such that the electric machine produces a demanded torque while the rotor current rises.

### CROSS-REFERENCE TO RELATED APPLICATION

This application claims benefit of, and priority to, U.S. Provisional Patent Application Ser. No. 63/413,298, filed Oct. 5, 2022, the entire contents of which are hereby incorporated by reference.

### BACKGROUND

### 1. Technical Field

The present disclosure relates to pulsed control of electric machines and, more specifically, to methods of improving the rate of rise of torque for externally excited synchronous machines.

### 2. Discussion of Related Art

Wound field synchronous machines may be wound field synchronous motors (WFSM) and wound field synchronous generators (WFSG). Wound field synchronous machines can also be referred to as an Externally Excited Synchronous machines have a separately excited rotor and a separately exited stator. This rotor can be feed via slip rings, a rotary magnet, or an inductively coupled rotary power transformer. Direct current can be provided to the rotor to excite the rotor and thus, produce magnetic flux of the rotor.

A multi-phase inverter can be used to generate a magnetic flux in the stator or stator flux. For example, the multi-phase inverter can be a 3-phase inverter that generates currents through the stator coils, and therefore generate magnetic flux in the stator. The magnetic flux of the rotor interacts in an air gap between the stator and the rotor with the stator flux to cause rotation of the rotor and produce power.

Conventional EESMs are designed to only require a small amount of current to be provided to the rotor compared to current provided to the stator. For example, the rotor may be provided with current in a range of 10-90 Amps and the stator may be provided with current in a range of 100-1000 Amps and sometimes greater than 1000 Amps. As a consequence, the rotor has a large number of turns and thus, high resistance and high inductance resulting in a high time constant which is not conducive to being turned On and Off at frequencies in the range of 5 to 100 Hz.

The high resistance and high inductance is not an issue when the EESM is delivering a constant level of power because once the magnetic flux of the rotor flux is established, the current provided to the rotor is not turned ON and OFF but controlled to a constant level based upon the maximum efficiency operation point of the EESM. However, when an EESM is pulsed ON and OFF such as during a Dynamic Motor Drive (DMD) control, the rotor current needs to be turned ON and OFF as fast as possible and as efficiently as possible.

### SUMMARY

This disclosure relates generally to a methods of controlling electric machines to increase a rate of rise of magnetic flux in the rotor of an EESM and thus a rate of rise of torque provided by the EESM. For example, the methods disclosed herein may decrease a time for an electric machine to transition from a zero or near zero torque to a desired pulsed torque as the electric machine is pulsed ON and OFF. The methods detailed herein may be used to improve a rate of fall of magnetic flux in a rotor of an EESM. In some embodiments, the methods detailed herein may be executed on a traditional EESM which is configured to operate in a continuous control mode without consideration for pulsed control. In certain embodiments, the methods detailed herein may be executed on an EESM which has been modified to operate in a pulsed mode.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a representative Torque/Speed/Efficiency graph illustrating the energy conversion efficiency of a representative electric motor under different operating conditions;

FIG. 2 is a graph illustrating a pulsed torque signal applied to an electric motor;

FIG. 3A is a torque versus efficiency map for a motor operating at a fixed speed during a transition from zero to peak efficiency torque;

FIG. 3B is a torque versus work lost for an example motor operating at a fixed speed during a transition from zero to peak efficiency torque;

FIG. 4 illustrates a pulsed controlled electric machine in accordance with a non-exclusive embodiment;

FIG. 5A is a diagrammatic representation of a continuous three-phase AC waveform having a peak value of 50 Amperes for armature windings;

FIG. 5B is a diagrammatic representation of a continuous DC signal at 5 Amperes for field windings;

FIGS. 5C and 5E are pulsed waveforms having a 50% duty cycle that provide the same power output as the continuous waveform of FIG. 5A;

FIGS. 5D and 5F are pulsed DC signals having a 50% duty cycle that provide the same power output as the continuous DC signal of FIG. 5B;

FIGS. 6A-6C are signal diagrams illustrating benefits of a non-exclusive embodiment;

FIG. 7 is a graph of a rise in magnetic flux over time in response to only a rotor current being applied;

FIG. 8 is a graph of a rise in magnetic flux over time in response to a rotor current and a field component of a stator current being applied at the same time;

FIG. 9 is a graph of the rise in rotor current over time with a field component of a stator current being applied at time zero and with a delayed field component of stator current;

FIG. 10 is a flow chart of a method of providing a demanded torque from an electric machine by maintaining a magnetizing flux while rotor current rises provided in accordance with the present disclosure;

FIG. 11 is a flow chart of a method of extracting energy as the magnetic flux decays provided in accordance with the present disclosure; and

FIG. 12 is a block diagram of an example controller that may perform one or more of the operations described herein.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the term “machine” is intended to be broadly construed to mean both electric motors and generators. Electric motors and generators are structurally very similar with both including a stator having a number of poles and a rotor. When a machine is operating as a motor, it converts electrical energy into mechanical energy and when operating as a generator, the machine converts mechanical energy into electrical energy.

Modern electric machines have relatively high energy conversion efficiencies. The energy conversion efficiency of most electric machines, however, can vary considerably based on their operational load. With many applications, a machine is required to operate under a wide variety of different operating load conditions. As a result, machines typically operate at or near the highest levels of efficiency at certain times, while at other times, they operate at lower efficiency levels.

Battery powered electric vehicles provide a good example of an electric machine operating at a wide range of efficiency levels. During a typical drive cycle, an electrical vehicle will accelerate, cruise, de-accelerate, brake, corner, etc. Within certain rotor speeds and/or torque ranges, the electric machine operates at or near is most efficient operating point, i.e., its “sweet spot”. Outside these ranges, the operation of electric machine is less efficient. As driving conditions change, the machine transitions between high and low operating efficiency levels as the rotor speed and/or torque changes. If the electric machine could be made to operate a greater proportion of a drive cycle in high efficiency operating regions, the range of the vehicle for a given battery charge level would be increased. Since the limited range of battery powered electric vehicles is a major commercial impediment to their use, extending the operating range of the vehicle is highly advantageous. A need therefore exists to operate electric machines, such as motors and generators, at higher levels of efficiency.

The present application relates generally to pulsed control of Externally Excited Synchronous Machines (EESM) that can be operated in a continuous or pulsed manner. By pulsed control, the machine is intelligently and intermittently pulsed on and off to both (1) meet operational demands while (2) improving overall efficiency compared to continuous control. More specifically, under selected operating conditions, an electric machine is intermittently pulse-driven at more efficient energy conversion operating levels to deliver the desired average output more efficiently than would be attained by continuous control. Pulsed control results in deliberate modulation of the electric machine torque; however, the modulation is managed in such a manner such that levels of noise or vibration are minimized for the intended application.

For the sake of brevity, the pulsed control of EESMs as provided herein is described in the context of a three-phase electric wound field synchronous motor in a vehicle. This explanation, however, should not be construed as limiting in any regard. On the contrary, the pulse control as described herein can be used for many types of electric wound field synchronous motor machines, meaning both electric motors and generators. In addition, pulsed control of such electric wound field synchronous machines may be used in any application, not just limited to electric vehicles. In particular, pulsed control may be used in systems that require lower acceleration and deceleration rates than vehicle applications, such as electric motors for heating, cooling, and ventilating systems. Pulsed engine control is described in U.S. Patent Publication No. 2019/0288629 which is incorporated herein by reference in their entirety.

### Wound Field Synchronous Machines

Wound field synchronous machines are motors or generators that are able to convert electricity to mechanical movement or mechanical movement to electricity without permanent magnets. Wound field synchronous machines may be wound field synchronous motors (WFSM) and wound field synchronous generators (WF SG). Wound field synchronous machines can also be referred to as Externally Excited Synchronous Machines (EESM). WFSMs may include wound field synchronous rotors, where a field coil (also called field windings) is located in the rotor, and armature phase windings in the stator. In a WFSM, the field coil is powered by a DC power source. In most WFSM, the armature windings are powered by an AC power source. In WFSMs, slip rings may be used to provide electrical contacts between the DC power source and the field coils on the rotor. In some embodiments, an air gap may be used to transfer power to field coils from DC power source.

### Three-Phase Externally Excited Synchronous Machines

In a three-phase EESM, the stator may include a three-coil winding that is excited by a three-phase AC input and the field coils on the rotor that are powered by a DC input. When the three-phase AC input is passed through the three-phase armature windings, a rotating magnetic field (RMF) is generated. The rotational rate of the RMF is known as the synchronous speed (Ns) of the electric machine. The interaction of the field coils of the rotor and the armature windings generate electromagnetic torque causing the rotor rotation.

### Vehicle Motor Efficiency Map

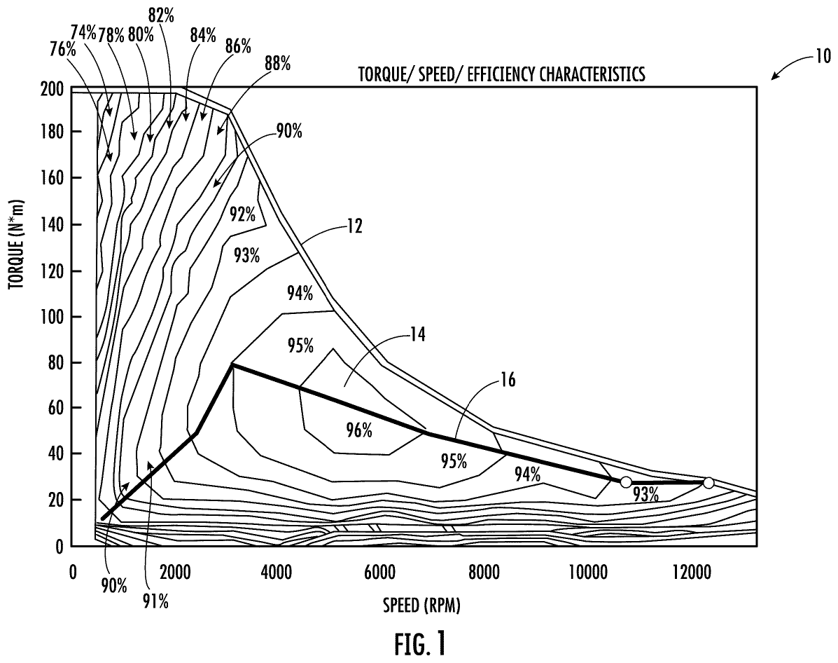

Referring to FIG. 1, an example vehicle motor efficiency map 10 under different load and speed conditions is illustrated. The map 10 plots torque (N*m) along the vertical axis as a function of motor speed (RPM) along the horizontal axis. The maximum steady-state output power is given by curve 12. The example vehicle motor efficiency map is shown to help illustrate an increase in efficiency of an EESM that may be provided by pulsed control of the EESM.

The area under the peak-torque/speed curve 12 is mapped into a plurality of regions, each labeled by an operational efficiency percentage. For the particular motor shown, the following characteristics are evident:
The most efficient or “sweet-spot” region of its operating range is the operating region labeled 14, which is generally in the range of 4,500-6,000 RPM with a torque output in the range of about 40-70 N*m. In region 14, the energy conversion efficiency is on the order of 96%, making it the “sweet spot”, where the motor is operating in its most efficient operating range.
As the motor speed increases beyond approximately 6,000+ RPM, the efficiency tends to decrease, regardless of the output torque.
As the output torque increases beyond 70 N*m or falls below 40 N*m, the efficiency percentage tends to decrease from its peak, in some situations rather significantly. For example, when the motor is operating at approximately 2,000 RPM and an output torque of 100 N*m, the efficiency is approximately 86%. When torque output falls below about 30 N*m, regardless of the motor speed, the efficiency drops, approaching zero at zero load.
At any particular motor speed, there will be a corresponding most efficient output torque, which is diagrammatically illustrated by a maximum efficiency curve 16.

The map 10 as illustrated was derived from an electric motor used in a 2010 Toyota Prius which utilizes an internal permanent magnet synchronous motor. It should be understood that this map 10 is merely illustrative and should not be construed as limiting in any regard. A similar map can be generated for just about any electric motor, for example a 3-phase induction motor, regardless of whether used in a vehicle or in some other application.

As can be seen from the map 10, the motor is generally most efficient when operating within the speed and torque ranges of the sweet spot 14. If the operating conditions can be controlled so that the motor operates a greater proportion of time at or near its sweet spot 14, the overall energy conversion efficiency of the motor can be significantly improved.

From a practical point of view, however, many driving situations dictate that the motor operate outside of the speed and torque ranges of the sweet spot 14. In electric vehicles it is common to have no transmission and as such have a fixed ratio of the electric motor rotation rate to the wheel rotation rate. In this case, the motor speed may vary between zero, when the vehicle is stopped, to a relatively high RPM when cruising at highway speeds. The torque requirements may also vary widely based on factors such as whether the vehicle is accelerating or decelerating, going uphill, going downhill, traveling on a level surface, braking, etc.

As can be seen in FIG. 1, at any particular motor speed, there will be a corresponding most efficient output torque which is diagrammatically illustrated by maximum efficiency curve 16. From a conceptual standpoint, when the desired motor torque is below the most efficient output torque for the current motor speed, the overall efficiency of the motor can be improved by pulsing the motor, so as to operate the motor a proportion of time at or near its sweet spot and the remainder of the time at a low or zero torque output level. The average torque thus generated is controlled by controlling the duty cycle of sweet spot operation.

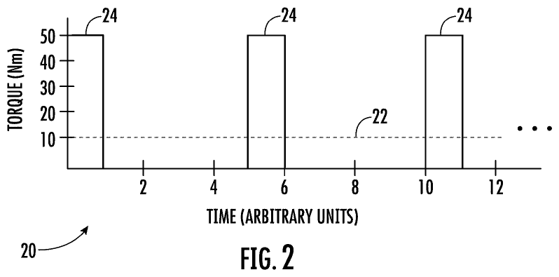

Referring to FIG. 2, a graph 20 plotting torque on the vertical axis versus time on the horizontal axis is illustrated. During conventional operation, the motor would continuously generate 10 N*m, indicated by dashed line 22, so long as the desired torque remained at this value. With pulsed-control operation, the motor is pulsed with a current pulse signal, as represented by pulses 24, to deliver 50 N*m of torque for 20% of the time. The remaining 80% of the time, the motor is off. The net output of the motor therefore meets the operational demand of an average torque level of 10 N*m. Since the motor operates more efficiently when it is delivering 50 N*m than when it delivers a continuous torque of 10 N*m, the motor's overall efficiency can thus be improved by pulsing the motor using a 20% duty cycle while still meeting the average torque demand. Thus, the pulsed operation provides a higher energy efficiency than the continuous operation.

In the above example, the duty cycle is not necessarily limited to 20%. As long as the desired motor output, does not exceed 50 N*m, the desired motor output can be met by changing the duty cycle. For instance, if the desired motor output changes to 20 N*m, the duty cycle of the motor operating at 50 N*m can be increased to 40%; if the desired motor output changes to 40 N*m, the duty cycle can be increase to 80%; if the desired motor output changes to 5 N*m, the duty cycle can be reduced to 10% and so on. Generally, pulsed motor control can potentially be used advantageously any time that the desired motor torque falls below the maximum efficiency curve 16 of FIG. 1.

On the other hand, when the desired motor torque is at or above the maximum efficiency curve 16, the motor may be operated in a conventional (continuous or non-pulsed) manner to deliver the desired torque. Pulsed operation offers opportunity for efficiency gains when the motor is required to deliver an average torque below the torque corresponding to its maximum operating efficiency point.

It should be noted that torque values and time scale provided in FIG. 2 are merely illustrative and are not intended to be limiting in any manner. In actual motor pulsing embodiments, the pulse duration used may widely vary based on the design needs of any particular system. In generally, however, the scale of the periods for each on/off cycle is expected to be on the order of 10 milliseconds (ms) to 0.10 seconds (i.e., pulsing at a frequency in the range of 10 to 100 Hz). Furthermore, there are a wide variety of different EESMs, and each EESM has its own unique efficiency characteristics. Further, at different motor speeds, a given motor will have a different efficiency curve. The nature of the curve may vary depending on the particular wound field synchronous motor or a particular application. For example, torque output need not be flat topped as depicted in FIG. 2 and/or the torque need not go to zero during the off periods but may be some non-zero value. Regardless of the particular curve used, however, at some proportion of the time the EESM is operating is preferably at or near its highest efficiency region for a given EESM.

### Efficiency Improvements for Improved Rate of Rotor Current Rise and Fall

The vast majority of current motor converters are typically designed for continuous operation, not pulsed operation. Such motors generally transition from the unenergized to an energized state relatively infrequently. As a result, little design effort is made in managing the rate of rotor current rise during such transitions. To the extent any design effort is made in managing the transition, it is typically directed to achieving a smooth transition as opposed to a fast transition. The transition from the un-energized to energized states for most motors is therefore often rate limited.

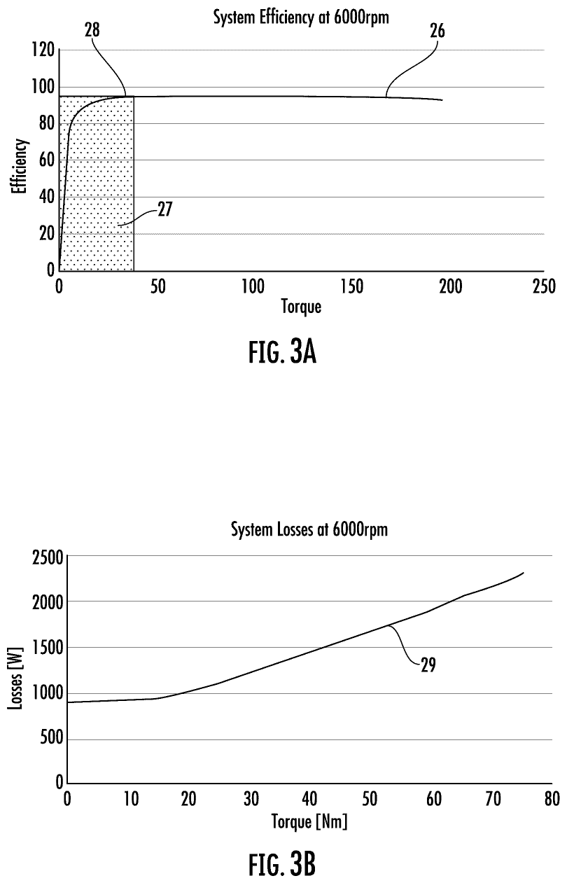

It has been discovered that for an electric motor that regularly transitions from an unenergized motor state to peak efficiency state such as with pulsed operation, even further efficiency improvements can be realized when the transitions occur as fast as possible, e.g., with an improved rate of rotor current rise. With fast transitions, for example from zero torque to the peak efficiency torque, the overall average motor efficiency is improved because the motor spends less time in transition where efficiency is less than the peak. This relationship is depicted in FIG. 3A and FIG. 3B

Referring to FIG. 3A, a torque versus efficiency map for an example electric motor operating at a fixed speed (e.g., 6000 rpms) is illustrated. In the example map, a range of torque outputs from 0.0 Nm to 250 Nm is plotted along the horizontal axis, while the efficiency of the motor from 0.0 percent to 100 percent is plotted along the vertical axis. The curve 26 depicts the transition of the motor from zero to peak efficiency torque. During this transition, as depicted by the shaded region 27, the motor achieves a higher efficiency at the peak efficiency torque 28 compared to efficiencies during the transition from zero to the peak efficiency torque.

Referring to FIG. 3B, a map is provided illustrating torque versus work lost for an example motor operating at a fixed speed during a transition from zero to peak efficiency torque. In this map, the work losses (W) are plotted along the vertical axis, while the torque output of the motor is plotted along the horizontal axis. As demonstrated by the curve 29, the work losses of the motor increase as the torque output increases during the transition from zero to peak efficiency torque. Therefore, the faster that transition time from zero to peak efficiency torque, the less work is performed, and the less energy is consumed by the electric motor.

By substituting time in place of torque along the horizontal axis and then integrating the area under the curve 29, the energy consumed by the electric motor can be calculated for a given transition time. For instance, with an example motor, 7234.5 Joules of energy was used with a transition time of 0.5 seconds, while only 723.4 Joules of energy were used a transition time of 0.05 second. This comparison demonstrates that the faster the transition time from zero to peak efficiency torque, the lower the energy consumed in losses. It should be noted that with this example, it is assumed that no acceleration of the load has taken place, so no energy has been added to the load inertia. Just as efficiency is increased by decreasing rise time, efficiency is increased by decreasing fall time.

For different motors, the transition of the motor from zero to peak efficiency torque, the peak efficiency torque and the work losses will vary. The maps of FIG. 3A and FIG. 3B should therefore be viewed as merely example and should not be construed as limiting in any regard.

### Power Converter

Power inverters are known devices that are used with electric motors for converting a DC power supply, such as that produced by a battery or capacitor, into multi-phase AC input power, e.g., three-phase AC input power, applied to motor stator windings. In response, the stator windings generate the RMF as described above.

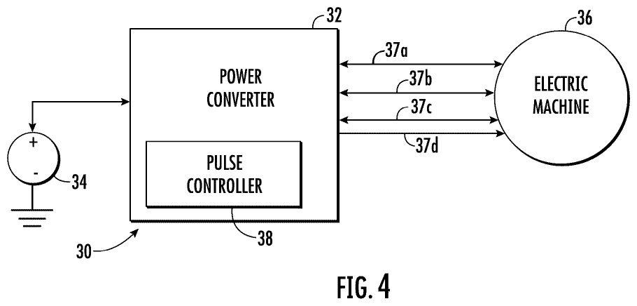

Referring to FIG. 4, a diagram of a power controller 30 for pulsed operation of an electric machine is illustrated. The power controller 30 includes a power converter 32, a DC power supply 34, and an electric machine 36. In this non-exclusive embodiment, the power converter 32 comprises a pulse controller 38. The power converter 32 may be operated as a power inverter or power rectifier depending on the direction of energy flow through the system. When the electric machine is operated as a motor, the power converter 32 is responsible for generating three-phased AC power from the DC power supply 34 to drive the electric machine 36. The three-phased input power, denoted as phase A 37a, phase B 37b, and phase C 37c, is applied to the windings of the stator of the electric machine 36 for generating the RMF as described above. The lines depicting the various phases, 37a, 37b, and 37c are depicted with arrows on both ends indicating that current can flow both from the power converter 32 to the electric machine 36 when the machine is used as a motor and that current can flow from the electric machine 36 to the power converter 32 when the machine is used as a generator. When the electric machine is operating as a generator, the power converter 32 operates as a power rectifier and the AC power coming from the electric machine 36 is converted to DC power being stored in the DC power supply. The line depicting the field current, 37d carries a DC field current that typically is unidirectional for both the motor and generator operating modes.

The pulse controller 38 is responsible for selectively pulsing the three-phased input power. During conventional (i.e., continuous) operation, the three-phased and field coil input power is continuous or not pulsed. On the other hand, during pulsed operation, the three-phased and field coil input power is pulsed. Pulsed operation may be implemented, in non-exclusive embodiments, using any of the approaches described herein, such as but not limited to the approaches described below.

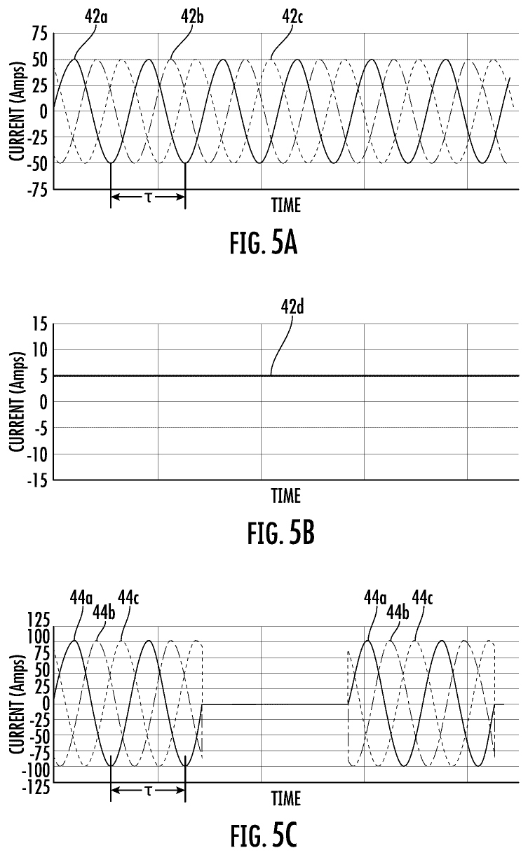

Referring to FIG. 5A-5F, plots are provided for illustrating the difference between continuous and pulsed three-phased and field current input power provided to the electric machine 36. In each plot, phase and field currents are plotted on the vertical axis and time is plotted along the horizontal axis.

FIG. 5A illustrates conventional sinusoidal three-phased input current 42a, 42b, and 42c delivered to the armature windings of the electric machine 36. Phase B, denoted by curve 42b lags phase A, denoted by 42a by 120 degrees. Phase C, denoted by curve 42c, lags phase B by 120 degrees. The sine wave period is T. The three-phased input current 42a, 42b, and 42c is continuous (not pulsed) and has a designated maximum amplitude of approximately 50 amps. FIG. 5B illustrates the conventional DC field current 42d delivered to the field coils. The field current is continuous (not pulsed) and has an amplitude of 5 amps. It should be appreciated that 50 amps (for the phased current delivered to the armature windings) and 5 amps (for the field current delivered to the field coils) are only a representative maximum current, and the maximum current may have any value.

FIG. 5C and FIG. 5D illustrate an example pulsed three-phased current waveforms 44a, 44b, and 44c, shown in FIG. 5C, with a pulsed DC field current 44d, shown in FIG. 5D that has a 50% duty cycle and peak amplitude of approximately 100 amps for the three-phased waveforms 44a, 44b, and 44c and approximately 10 amps for the field current 44d. As in FIG. 5A the period of the base sine wave is ti, however, now the sine wave is modulated on and off. The delivered currents in FIG. 5C and FIG. 5D deliver the same average torque as the continuously applied three-phased input current of FIG. 5A and FIG. 5B (assuming torque is proportional to currents, which is often the case). In FIG. 5C and FIG. 5D, the current pulses 44a-d are interleaved with “off” periods of equal length. The length of each on and off period is 2-c. In this example, the duty cycle is 50%. The frequency of the pulsed modulation may vary based on the type of electrical machine used, noise and vibration considerations, current operating rotor speed, and other factors.

This example in FIG. 5C and FIG. 5D illustrates an application in which the “on” motor drive pulses are evenly spaced while the motor is operated at a steady state desired output level. Such an approach works well in many circumstances but is not a requirement. The duty cycle need not be 50% but can be adjusted to match the desired average output torque. In FIG. 5C and FIG. 5D the phase of the on/off pulses is synchronized with the applied power; however, the phase of the on/off pulses need not be synchronized with the phase of the applied power in some embodiments. Thus, the relative sizes and/or timing of the motor drive pulses can be varied as long as they average out to deliver the desired average torque.

This example shows how both the armature winding AC current and the DC field coil current may be pulsed. The pulsing is designed to allow the EESM to operate at an efficient torque level, while reducing the amount of power needed to provide a desired torque level.

FIG. 5E and FIG. 5F illustrate another example of pulsed three-phased current waveforms 46a, 46b, and 46c, shown in FIG. 5E, with a pulsed DC field current 46d, shown in FIG. 5F that has a 50% duty cycle and peak amplitude of approximately 100 amps for the three-phased waveforms 46a, 46b, and 46c and approximately 10 amps for the field current 46d. As in FIG. 5A the period of the base sine wave is ti, however, now the sine wave is modulated on and off. The delivered current in FIG. 5E and FIG. 5F delivers the same average torque as the continuously applied three-phased input current of FIG. 5A and FIG. 5B (assuming torque is proportional to currents, which is often the case). In FIG. 5E and FIG. 5F, the current pulses 46a-d are interleaved with “off” periods of equal length. The length of each on and off period is τ/2. In this example, the duty cycle is 50%. The frequency of the pulsed modulation may vary based on the type of electrical machine used, noise and vibration considerations, current operating rotor speed, and other factors.

### Power Converter Circuit

The inherent inductance of the motor can transitorily delay/slow the power/current steps between the on and off motor states. During continuous (non-pulsed) operation, these transitory effects tend to have a relatively minimal impact on overall motor operation. However, when rapid pulsing is used as contemplated herein, the transitory effects can have a larger net impact, and therefore, there is an incentive to reduce the leading and falling edge pulse transition times. This is particularly important for the field current that can take significantly longer to build magnetic flux in the rotor than it takes for the stator to build stator flux when a current is applied to the stator windings.

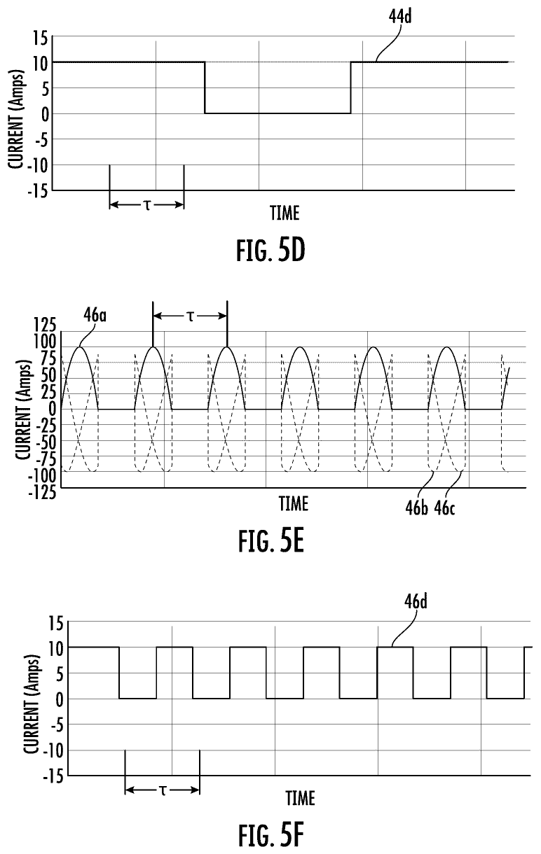

As previously noted, the goal of pulsed motor control is to operate the electric machine 36 at substantially its most efficient level for the current machine speed during “on” periods and to cut-off power (provide zero or negligible power) during the “off” periods. For example, the power supplied during the off periods may be less than 10%, 5%, 1%, 0.5%, or 0.1% of the power supplied during the “on” period. The operating point while operating during the “on” period may have an efficiency within 5%, 2%, or 1% of a maximum operating efficiency point of the motor at the current motor speed. The transitions thru the low efficiency operating region between the “off” and “on” periods should be as fast as possible to maximize efficiency. Thus, the power transitions between the machine power “on” and “off” states ideally have a leading edge that transitions vertically straight up and a following edge that vertically transitions straight down. Such “perfect” pulses 60 are diagrammatically illustrated in FIG. 6A, which illustrates the ideal motor drive current versus time for pulsed control having a duty cycle of 50%. In this figure, the current pulse represents the field winding current. While the current pulse is shown as flat topped, this will not necessarily be the case.

In the real-world, a number of practical limitations make generation of such perfect pulses difficult to achieve. For instance, inductive aspects of both the electric machine 36 and the power converter 32 circuitry slow down the current rise and fall times. The actual response of a particular machine will vary with the electrical characteristics of the electric machine 36, the rotational speed of the electric machine and the available bus voltages. In general, the actual rise and fall of pulses occur more gradually, meaning the transitions occur over time. The nature of the rise and fall in the real-world is diagrammatically illustrated in FIG. 6B. As seen therein, there is a ramp-up period (rise time) 62 required for the current to actually rise from zero to the desired “on” power level and a ramp-down period (fall time) 64 required for the current to actually fall from the “on” power level down to zero.

During the power ramp-up and ramp-down periods, the wound field synchronous machine 36 continues to consume or generate power. However, the wound field synchronous machine operates less efficiently during these transition periods. In general, the wound field synchronous machine efficiency will drop as the operating current drops from its maximum efficiency condition (curve 16 FIG. 1) towards zero, with the energy conversion efficiency getting noticeably worse as the current level approaches zero. Thus, the pulse distortion represented by the current ramp-up and ramp-down periods detract from efficiency gains resulting from pulsed operation. In general, the smaller the ratio of the rise/fall times to the pulse length, the less the transitory switching effects impact the machine's energy conversion efficiency during pulsing.

It should be appreciated that the transitory effects shown in FIG. 6B are illustrative in nature and do not necessarily reflect actual rise/fall times associated with operation of any particular wound field synchronous machine. The relative scale of the rise time to the pulse length ratio can vary widely based on the characteristics of the wound field synchronous machine used (which primarily dictates the rise and fall times), the frequency of the pulsing (which is primarily dictated by the control scheme used) and the pulse width (which is dictated by the control scheme and machine load). The voltage available to power the wound field synchronous electric machine and machine rotation speed will also impact the pulse rise and fall times. If the pulsing is slow compared to the wound field synchronous machine response, the rise/fall times may be a small fraction of the pulse width and the transitory switching effects may have a minimal impact on machine performance. Conversely, if the pulsing is very rapid and/or the wound field synchronous machine response is low, the rise/fall times may be a significant fraction of the pulse width and can even exceed the pulse width in some situations. If not managed carefully, the transitory efficiency losses associated with switching can significantly reduce or even eliminate any theoretical gains that can be attained by pulsed operation. Thus, it is important to consider the transitory switching effects associated with pulsed operation when determining the pulsing frequency and control schemes that are appropriate for any particular application.

As noted above, for continuous control of an electric machine there is not a need to improve a rate of torque buildup in the electric machine. In contrast, for pulsed control of an electric machine, e.g., DMD, there is a need to improve a rate of torque buildup in the electric machine.

One method of improving a rate of torque buildup in the electric machine is to use a field component of the stator current in parallel with the rotor current to accelerate the buildup of magnetizing flux in the electric machine. In some embodiments, the field component and the rotor current may be started simultaneously. In certain embodiments, the field component current may be established before applying the rotor current.

In order to accelerate the buildup of the magnetizing flux in the electric machine, it may be possible to apply both the rotor current and the field component at the same time. Below are several equations that define properties of an EESM:

$$\\ {λ}_{d} = {L}_{d} {i}_{d} + {L}_{m} {i}_{r}$$

$$\\ {λ}_{q} = {L}_{q} {i}_{q}$$

$$\\ {λ}_{0} = {L}_{0} {i}_{0}$$

$$\\ {λ}_{r} = 3 * \frac{pp}{2} * {L}_{m} {i}_{d} + {L}_{r} {i}_{r}$$

$$\\ {v}_{d} = {R}_{s} {i}_{d} + \frac{d}{dt} {λ}_{d} - ω {λ}_{q}$$

$$\\ {v}_{q} = {R}_{s} {i}_{q} + \frac{d}{dt} {λ}_{q} + ω {λ}_{d}$$

$$\\ {v}_{0} = {R}_{s} {i}_{0} + \frac{d}{dt} {λ}_{0}$$

$$\\ {v}_{r} = {R}_{r} {i}_{r} + \frac{d}{dt} {λ}_{r}$$

$$\\ Torque = 3 pp / 2 ( {λ}_{d} {i}_{q} - {λ}_{q} {i}_{d} ) = 3 pp / 2 ( ( {L}_{d} - {L}_{q} ) {i}_{d} {i}_{q} + {L}_{m} {i}_{r} {i}_{q} )$$

Where λ_{d} is the magnetic flux of the electric machine, i_{d} is the field component of the stator current, and it is the rotor current. In addition, λ_{q} is the torque flux of the electric machine where i_{q} is the torque component of stator current.

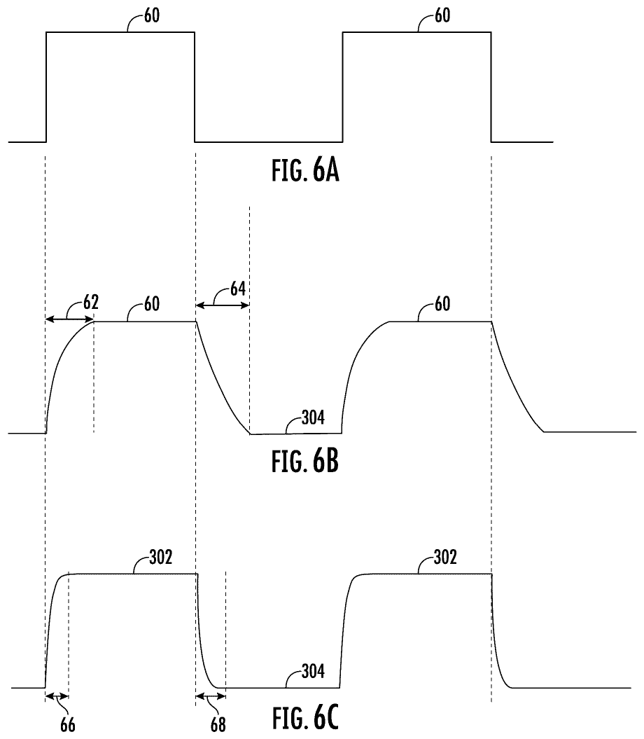

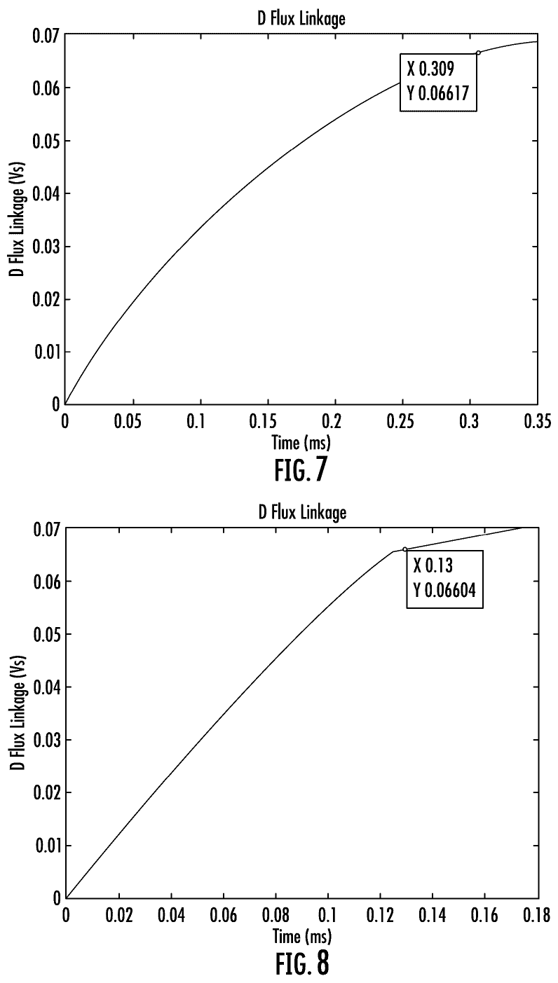

It will be appreciated that the number of turns of the rotor windings result in a higher inductance and thus a slower rise of rotor current than the rise of stator current. Thus in view of the equations above, the magnetic flux will rise faster as a result of exciting the stator with stator current than from exciting the rotor with rotor current when both are excited at the same time, e.g., λ_{d}=L_{d}i_{d}+Lₘiᵣ. This is shown in FIGS. 7 and 8 where FIG. 7 shows the rise in magnetic flux with only rotor current (iᵣ) being applied where it takes 0.31 ms to rise to 0.066 Vs. In contrast, when the field component of the stator current (i_{d}) is applied at the same time as rotor current (iᵣ), the magnetic flux builds to 0.066 Vs in 0.13 ms. It is noted that in FIG. 8 there is a discontinuity in the building of magnetic flux at 0.13 ms which is the result of a field current limit. The field current limit may be increased at a cost of additional losses in the stator. In some embodiments, the field current limit can be lowered which would result in the time to achieve the same magnetic flux increasing. The field current limit may be controlled by regulating a voltage used to excite the stator.

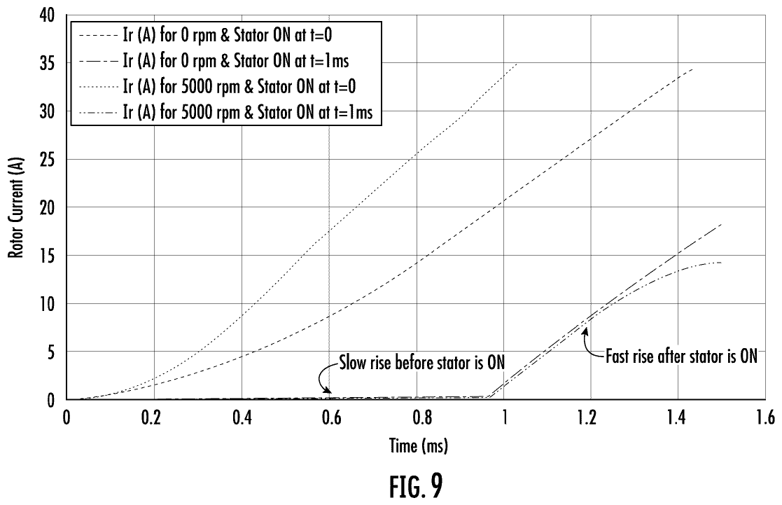

With reference to FIG. 9, the effect of delaying the field component of the stator current is shown for two different speeds of the electric machine. When only the rotor current is applied, the rise in rotor current is slow until the field component of the stator current is added. In contrast, when the field component of the stator current is applied at the same time as the rotor current, the rotor current rises quickly. This reduction in time to establish rotor current can be used to produce torque by applying torque component of the stator current once the rotor current reaches a predetermined minimum or when the magnetic flux of the electric machine reaches a predetermined minimum.

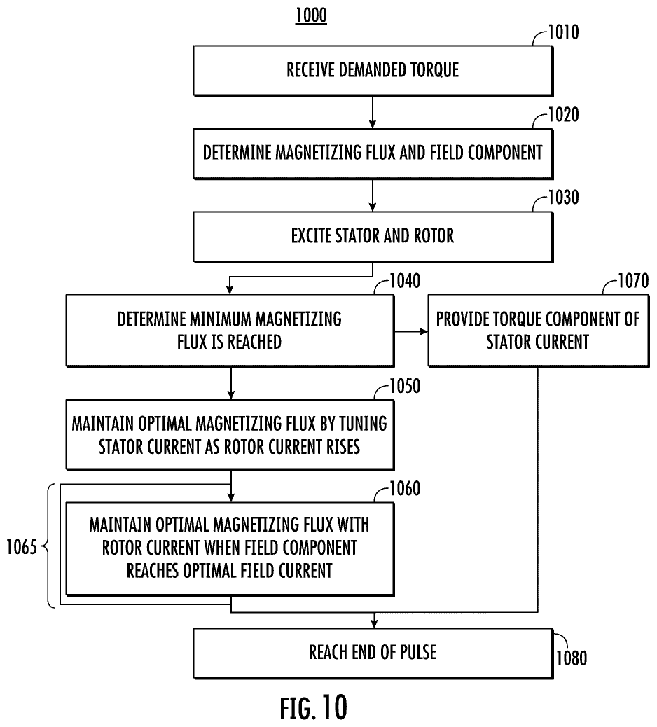

Referring now to FIG. 10, a method of optimizing control of magnetic flux to increase efficient torque delivery from an electric machine which is referred to generally as method 1000. As described in greater detail below, the stator is excited with the field component of the stator current and the rotor is excited with rotor current at the same time to produce a predetermined magnetizing flux. In addition, the method 1000 may include applying a torque component of the stator current during as the rotor is rising to increase an efficiency of torque production. Specifically, the torque component may be applied while the rotor current is rising such that losses during the rise of the rotor current are minimized. The increase of the torque component may be limited by constraints of the electric machine, the inverter, voltage, current, or temperature.

To being torque delivery, a demanded torque is received by the controller (Step 1010). The controller determines an optimal magnetizing flux for the electric machine and an optimal field current for the demanded torque (Step 1020). The controller may calculate the optimal magnetizing flux and/or the optimal field current for the demanded torque or may use look up tables to determine the optimal magnetizing flux and/or the optimal field current. In some embodiments, the controller calculates an optimal field current limit for the demanded torque. With the optimal magnetizing flux and the optimal field current calculated, the stator is excited by providing a field component of the stator current to the stator of the electric machine and at the same time the rotor is excited by providing a rotor current to the rotor the electric machine (Step 1030). The field component of the stator current may be provided at a predetermined limit for the optimal magnetizing flux while the rotor current increases. When the optimal field current limit is calculated, the predetermined limit for the field component of the stator current is the calculated optimal field current limit.

As a result of the excitation of the stator and the rotor, the magnetizing flux of the rotor rises. When the controller determines that the optimal magnetizing flux is reached, the controller reduces the field component of stator current as rotor current increases such that the optimal magnetizing flux is maintained (Step 1050). The field component is reduced until the optimal field current is reached for the demanded torque. While the filed component of the stator current is reduced, the torque component of the stator current may be increased. The controller controls the rotor current when the field component reaches the optimal field current to maintain the optimal magnetizing flux during torque delivery (Step 1060). The controller may include a control loop 1065 to maintain the magnetic flux at the optimal magnetic flux by repeating step 1060 during delivery of the torque component of the stator current. The control loop 1065 may maintain the optimal magnetizing flux by reducing the field component of the stator current as the rotor current rises until the field component is reduced to the optimal field component at which point the controller maintains the magnetizing flux by varying the rotor current.

When a minimum magnetizing flux is reached at Step 1040, the controller provides a torque component of the stator current to the stator (Step 1070). The minimum magnetizing flux may be a magnetizing flux that is sufficient allow delivery of torque from the electric machine. The minimum magnetizing flux may be less than or equal to the optimal magnetizing flux. The minimum magnetizing flux and/or the optimal magnetizing flux may be reached while the rotor current is rising. As such, the electric machine may deliver torque while the rotor current continues to rise. Providing the torque component of the stator current as the rotor current is rising may increase an efficiency of the electric machine. The controller may continue to run the control loop 1065 while the torque component is provided to the stator to maintain the magnetizing flux at the optimal magnetizing flux during torque delivery. When the pulse or torque delivery is completed (Step 1080), the controller may terminate delivery of the torque and field components of the stator current and the rotor current. It may be possible to rapidly cease torque by eliminating the magnetizing flux by making −L_{d}i_{d}=Lₘiᵣ such that the magnetizing flux equals zero and thus, no torque is provided. However, this may not be desirable or efficient.

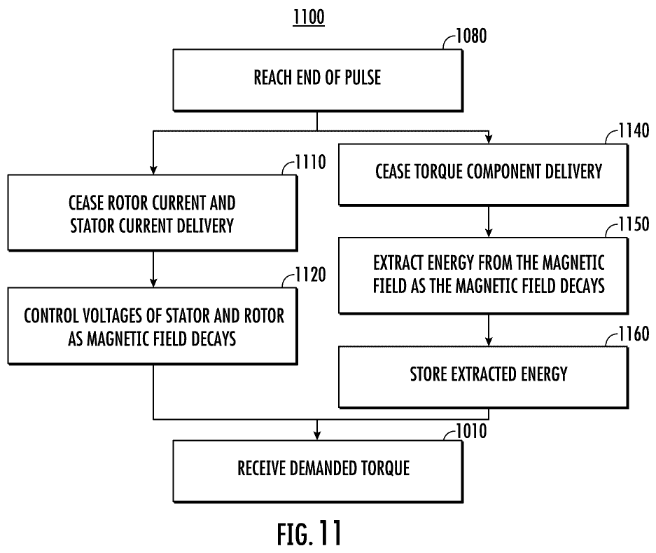

With reference to FIG. 11, a method of extracting energy as the magnetic flux decays is provided in accordance with the present disclosure and is referred to generally as method 1100. When the end of the pulse or torque delivery is reached at step 1080, the controller ceases delivery of rotor current and field component (Step 1110) and delivery of the torque component (Step 1140). As a result of the rotor current and the field component being terminated, the magnetic flux will decay or drawn down but will not cease immediately. The voltages of the stator and the rotor may be controlled during the decay of the magnetic flux (Step 1120). As the magnetic flux decays, energy may be extracted from the stator as the rotor continues to rotate (Step 1150). The energy from the stator may be stored locally for use during the next pulse or may be sent to a main battery for storage (Step 1160). In some embodiments, the energy from the stator may be provided back to the stator as the field component or as the torque component of the stator current when a new torque is demanded from the controller.

Extracting energy from the field of the magnetic flux as the magnetic flux decays may increase an efficiency of the electric machine during termination of torque delivery. This energy extraction may occur at the termination of torque delivery in a continuous control mode or between pulses during a pulsed control mode of the electric machine.

The methods 1000 and 1100 may be used to produce a fast and highly efficient transition from a zero torque to a peak efficient torque and symmetry back to a zero torque. This fast and highly efficient transition may be used during a pulsed mode of an electric machine or during a continuous mode of an electric machine. The optimization of the field component and the torque component of the stator current and the rotor current may be constrained by available voltage and current of both the stator and the rotor drive circuits. In some embodiments, the drive circuits for the stator and/or the rotor may be modified to increase an available voltage or current to improve optimization of the field component and the torque component of the stator current and/or the rotor current.

The methods 1000 and 1100 detailed above, may be used without modification to the electric machine 36 that was constructed or configured to for operation in a continuous control mode, e.g., the EESM. In some embodiments, the methods 1000 and 1100 detailed above may be combined with a modified electric machine. For example, the number of turns of the rotor may be modified to increase the rate of rise of torque of an EESM in combination with the method detailed above. For additional information on modifying the number of turns of the rotor to increase the rate of rise of torque of an EESM, reference may be made to U.S. patent application Ser. No. 18/184,569, filed Mar. 15, 2023.

In some embodiments, the methods 1000 and 1100 may be used in conjunction with boosting the rotor control drive voltage. Examples of boosting the rotor supply circuit are disclosed in co-owned U.S. patent application Ser. No. 18/404,103, filed Mar. 28, 2023.

In some embodiments, the methods 1000 and 1100 may be used in conjunction with methods for maintaining a minimum magnetizing flux in the electric machine. Examples of maintaining a minimum magnetizing flux are disclosed in co-owned U.S. patent application Ser. No. 18/452,050, filed Aug. 18, 2023, and U.S. patent application Ser. No. 18/452,260, filed Aug. 18, 2023.

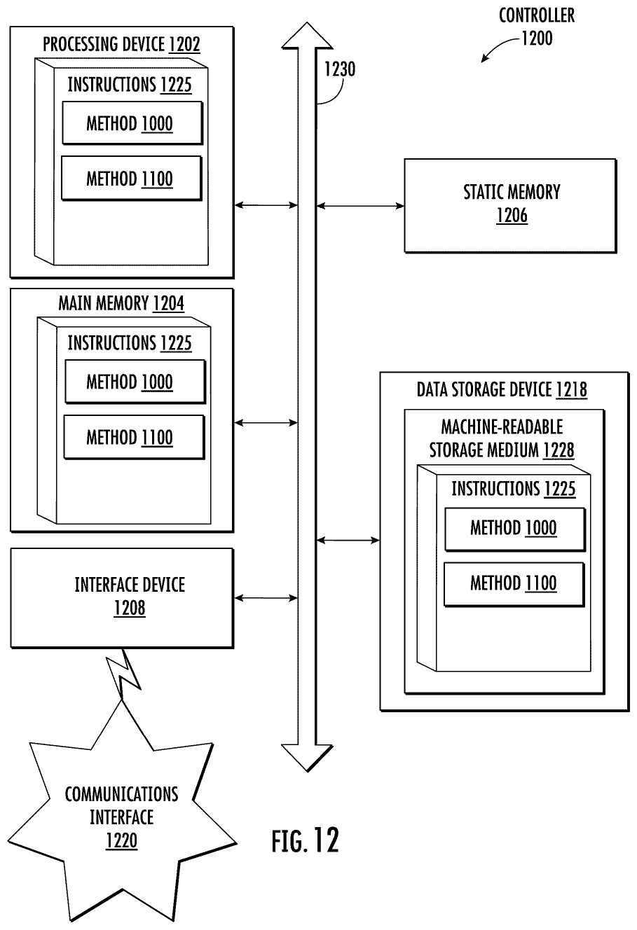

FIG. 12 is a block diagram of an example controller 1200 that may perform one or more of the operations described herein, in accordance with some embodiments. For example, the controller 1200 may be used as the power controller 30 or the pulse controller 32 detailed above. The controller 1200 may be in signal communication with other computing devices or controllers by being integrated therewithin or connected via a LAN, an intranet, an extranet, and/or the Internet. In some embodiments, while only a single controller is illustrated, the term “controller” may be taken to include any collection of controllers that individually or jointly execute a set (or multiple sets) of instructions to perform the methods discussed herein.

The example controller 1200 may include a processing device (e.g., a general-purpose processor, a PLD, etc.) 1202, a main memory 1204 (e.g., synchronous dynamic random access memory (DRAM), read-only memory (ROM)), a static memory 1206 (e.g., flash memory and a data storage device 1218), which may communicate with each other via a bus 1230.

Processing device 1202 may be provided by one or more general-purpose processing devices such as a microprocessor, central processing unit, or the like. In an illustrative example, processing device 1202 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1202 may comprise one or more special-purpose processing devices such as an application specific integrated circuit (ASIC), a field programmable gate array (FPGA), a digital signal processor (DSP), network processor, or the like. The processing device 1202 may be configured to execute the operations described herein, in accordance with one or more aspects of the present disclosure, for performing the operations and steps discussed herein.

Computing device 1200 may include a network interface device 1208 which may communicate with a communication network 1220. The computing device 1200 may include a video display unit (e.g., a liquid crystal display (LCD) or a cathode ray tube (CRT)), an alphanumeric input device (e.g., a keyboard), a cursor control device (e.g., a mouse) and an acoustic signal generation device (e.g., a speaker). In one embodiment, a video display unit, alphanumeric input device, and cursor control device may be combined into a single component or device (e.g., an LCD touch screen).

Data storage device 1218 may include a computer-readable storage medium 1228 on which may be stored one or more sets of instructions 1225 that may include instructions for one or more components (e.g., the electric machine 36) for carrying out the operations described herein, in accordance with one or more aspects of the present disclosure. Instructions 1225 may reside, completely or at least partially, within main memory 1204 and/or within processing device 1202 during execution thereof by computing device 1200, main memory 1204 and processing device 1202 constituting computer-readable media. The instructions 1225 may be transmitted or received over a communication interface 1220 via interface device 1208. The instructions 1225 may include instructions to perform the methods 1000 and 1100 detailed above.

While computer-readable storage medium 1228 is shown in an illustrative example to be a single medium, the term “computer-readable storage medium” should be taken to include a single medium or multiple media (e.g., a centralized or distributed database and/or associated caches and servers) that store the one or more sets of instructions. The computer-readable storage medium 1228 may include instructions 1225 including, but not limited to, instructions to perform the methods 1000 and 1100. The term “computer-readable storage medium” may be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Examples described herein may relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. The terms “comprises”, “comprising”, “includes”, and/or “including”, when used herein, may specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

In some embodiments, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in a manner that is capable of performing the task(s) at issue. “Configured to” may include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or an unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A method of controlling an electric machine having a separately excitable rotor and stator, the method comprising:
exciting the rotor and the stator to generate an optimal magnetic flux in the electric machine;
maintaining the optimal magnetic flux by tuning a stator current as a rotor current rises; and
providing a torque component of the stator current to the stator as the rotor current rises such that the electric machine produces a demanded torque while the rotor current rises.

2. The method of claim 1, wherein turning the stator current includes reducing a field component of a stator current as the rotor current rises.

3. The method of claim 1, wherein exciting the stator includes exciting the stator with a field component of the stator current.

4. The method of claim 3, wherein exciting the stator with the field component of the stator current includes exciting the stator current with he field component at the same time as exciting the rotor with the rotor current.

5. The method of claim 3, wherein exciting the stator with the field component of the stator current includes exciting the stator current with the field component after exciting the rotor with the rotor current.

6. The method of claim 3, wherein exciting the stator with the field component of the stator current includes the field component being at an upper field current limit.

7. The method of claim 6, wherein maintaining the optimal magnetic flux includes reducing the field component of the stator current from the upper field current limit.

8. The method of claim 1, wherein maintaining the optimal magnetic flux includes reducing the field component of the stator current until the field component reaches an optimal field current for the demanded torque.

9. The method of claim 8, further comprising determining the optimal field current before exciting the rotor and the stator.

10. The method of claim 1, wherein providing the torque component of the stator current to the stator begins after a minimum magnetic flux is first generated.

11. The method of claim 1, further comprising determining that the optimal magnetic flux is reached after providing the torque component of the stator current to the stator.

12. The method of claim 1, wherein exciting the rotor and the stator includes the rotor current and the stator current being zero immediately before exciting the rotor and the stator.

13. The method of claim 1, further comprising determining the optimal magnetic flux for the demanded torque before exciting the rotor and the stator.

14. The method of claim 1, further comprising:
ceasing the torque component of the stator current delivery and excitation of the rotor and the stator; and
extracting energy from a magnetic field of the electric machine as the magnetic field decays.

15. The method of claim 14, further comprising controlling currents of the stator and the rotor as the magnetic field decays to maintain the magnetic flux.

16. The method of claim 14, further comprising controlling voltages of the stator and the rotor as the magnetic field decays to maintain the magnetic flux

17. The method of claim 14, further comprising storing the energy extracted.

18. The method of claim 1, wherein providing the torque component to the stator as the rotor current rises minimizes loss of energy during the rise of the rotor current.

19. A controller for controlling an electric machine having a separately excitable rotor and stator, the controller comprising:
a memory; and
a processing device, operatively coupled to the memory, to:
excite the rotor and the stator at to generate an optimal magnetic flux in the electric machine;
maintain the optimal magnetic flux by tuning a stator current as a rotor current rises; and
provide a torque component of the stator current to the stator as the rotor current rises such that the electric machine produces a demanded torque while the rotor current rises.

20. A non-transitory computer-readable medium storing instructions that, when executed by a processing device, cause the processing device to control an electric machine having a separately excitable rotor and stator by:
exciting the rotor and the stator to generate an optimal magnetic flux in the electric machine;
maintaining the optimal magnetic flux by tuning a stator current as a rotor current rises; and
providing a torque component of the stator current to the stator as the rotor current rises such that the electric machine produces a demanded torque while the rotor current rises.
